(19) United States
(12) Patent Application Publication
(10) Pub. No.: US 2021/0382456 A1
(43) Pub. Date: Dec. 9, 2021

(54) PLANT MONITORING AND CONTROL SYSTEM, METHOD, AND PROGRAM

(71) Applicant: Hitachi, Ltd., Tokyo (JP)

(72) Inventors: Hiroaki WATAHIKI, Tokyo (JP); Makiko MURAKAMI, Tokyo (JP); Yasushi NISHIYAMA, Tokyo (JP)

(21) Appl. No.: 17/230,031

(22) Filed: Apr. 14, 2021

(30) Foreign Application Priority Data
Jun. 9, 2020 (JP) 2020-100229

(51) Int. Cl. G05B 19/406; G06F 3/14; G06F 16/17

(52) U.S. Cl. CPC G05B 19/406; G05B 2219/34427; G06F 16/1734; G06F 3/14

(57) ABSTRACT

A plant monitoring and control system for a batch control of a plant includes a database that stores a status at a time of executing a past batch control for the plant as an operation log regarding an operating device and as an alarm log at a time of an alarm occurrence, a first log analysis processing unit that extracts first information regarding a pre-alarm device operation occurs from the database, and a second log analysis processing unit that extracts a fact that the pre-alarm device operation is executed for one device multiple times as second information regarding the pre-alarm device operation. The second information is prompted to be verified.

### CLAIM OF PRIORITY

The present application claims priority from Japanese Patent application serial no. 2020-100229, filed on Jun. 9, 2020, the content of which is hereby incorporated by reference into this application.

### BACKGROUND OF THE INVENTION

### 1. Field of the Invention

The present invention relates to a plant monitoring and control system, a method, and a program used for monitoring and controlling a process in a plant, and particularly to a plant monitoring and control system, a method, and a program which are suitable for a plant for performing a batch process.

### 2. Description of the Related Art

Conventionally, in plants such as gas manufacturing plants, power plants, and sewage treatment plants, the plant process is monitored and controlled by a plant monitoring and control system configured by using a computer.

In recent years, it has become difficult to operate the plant safely due to the decrease in skilled operators, and it is an urgent task to train young operators. For this reason, it is being studied to contribute to the operation support of young operators by creating and presenting the operation information of veteran operators using the operation logs and alarm information of the monitoring operation terminals.

For example, for the purpose of providing a monitoring and control support device that provides an operator with appropriate data without missing a timing so that even an inexperienced operator can execute an operation at an appropriate timing, JP 2019-121257 A proposes “The data collection unit 11 collects information such as the monitoring screen, the monitoring screen name and its display time, and the operation content when the operator operates the monitoring terminal 2, and the data analysis unit 13 analyzes the importance and the like according to the type of data (information) from the terminal information database 12, and extracts recommended information candidate data. The recommended information editing unit 15 selects and registers recommended information formal data. The recommended information search unit 17 acquires information to be searched from the monitoring terminal 2, and searches data (information) suitable for searching conditions. The recommended information display unit 19 transmits the data (information) to the monitoring terminal 2, and displays the data.”

### SUMMARY OF THE INVENTION

As illustrated in JP 2019-121257 A, with regard to the operation support technology, there are processes utilizing technologies such as AI, presentation of predictive information of facility failure, and operation support, but there is a high hurdle to introduction such as a need of dedicated functions or facilities, a need of new data for predictive diagnosis.

When applying operation support technology, it is considered to configure an online control monitoring system that configures an engineer education system using a simulator that uses an offline plant model system, provides guidance for the next process to the operator, or presents prediction results.

However, even if the online control and monitoring system to which the operation assist technology is applied is configured, if the control target plant performs a batch process, it is important to determine the first procedure for instructing the start of the batch process, and to monitor the operation, and training of operators specializing in the batch process and management and operation are expected.

From the above, an object of the invention is to provide a plant monitoring and control system, a method, and a program capable of realizing an operation support technology suitable for the batch process with a simple device configuration.

From the above, in the invention, there is provided “a plant monitoring and control system for a batch control of a plant, which includes a database that stores a status at a time of executing past batch control for the plant as an operation log regarding an operating device and as an alarm log at a time of alarm occurrence, a first log analysis processing unit that extracts first information regarding a pre-alarm device operation occurs from the database, and a second log analysis processing unit that extracts a fact that the pre-alarm device operation is executed for one device multiple times as second information regarding the pre-alarm device operation. The second information is prompted to be verified”.

Further, in the invention, there is provided “a plant monitoring control method for performing a batch control for a plant, which includes storing a status at a time of executing a past batch control for the plant as an operation log regarding an operating device and as an alarm log at a time of alarm occurrence, extracting first information regarding a pre-alarm device operation from the stored information, extracting a fact that the pre-alarm device operation is executed for one device multiple times as second information regarding the pre-alarm device operation, and prompting the second information to be verified”.

Further, in the invention, there is provided “a plant monitoring and control program for referring to a database that stores a status at a time of executing a past batch control for a plant as an operation log regarding an operating device and as an alarm log at a time of alarm occurrence, and for a batch control of the plant, which includes a first log analysis processing program that extracts first information regarding a pre-alarm device operation from the database, a second log analysis processing program that extracts a fact that the pre-alarm device operation is executed for one device multiple times as second information regarding the pre-alarm device operation, and a displaying program that prompts verification of the second information”.

According to the invention, it is possible to provide a plant monitoring and control device and a method capable of realizing an operation support technology suitable for performing a batch process with a simple device configuration. Specifically, it is possible to support operator training by utilizing the existing log without significantly expanding the functions.

### BRIEF DESCRIPTION OF THE DRAWINGS

FIG. 1 is a diagram illustrating a configuration example of a plant monitoring and control system applied to a batch control plant;

FIG. 2 is a diagram illustrating an example of a plant status monitoring screen;

FIG. 3 is a diagram illustrating an example of a trend graph screen;

FIG. 4 is a diagram illustrating an example of the status monitoring screen when an alarm is issued;

FIG. 5 is a diagram illustrating an example of log information held in a log file;

FIG. 6 is a diagram illustrating the details of an operation log L1;

FIG. 7 is a diagram illustrating the details of information in an alarm log L2;

FIG. 8 is a diagram illustrating processing contents of a plant monitoring and control system according to an embodiment of the invention;

FIG. 9 is a diagram illustrating the details of analysis target user information D1;

FIG. 10 is a diagram illustrating a processing flow of a log analysis processing unit 14 according to the embodiment of the invention;

FIG. 11 is a diagram illustrating the correspondence between a screen and a tag number defined in a device displayed on the screen;

FIG. 12 is a diagram illustrating a processing flow of a log analysis processing unit 16 according to the embodiment of the invention;

FIG. 13 is a diagram illustrating the details of batch control information D4;

FIG. 14 is a diagram illustrating a flow illustrating the processing contents of an operation display processing unit 19; and

FIG. 15 is a diagram illustrating a configuration example of an operation screen 100.

### DESCRIPTION OF THE PREFERRED EMBODIMENTS

Hereinafter, embodiments of the invention will be described with reference to the drawings.

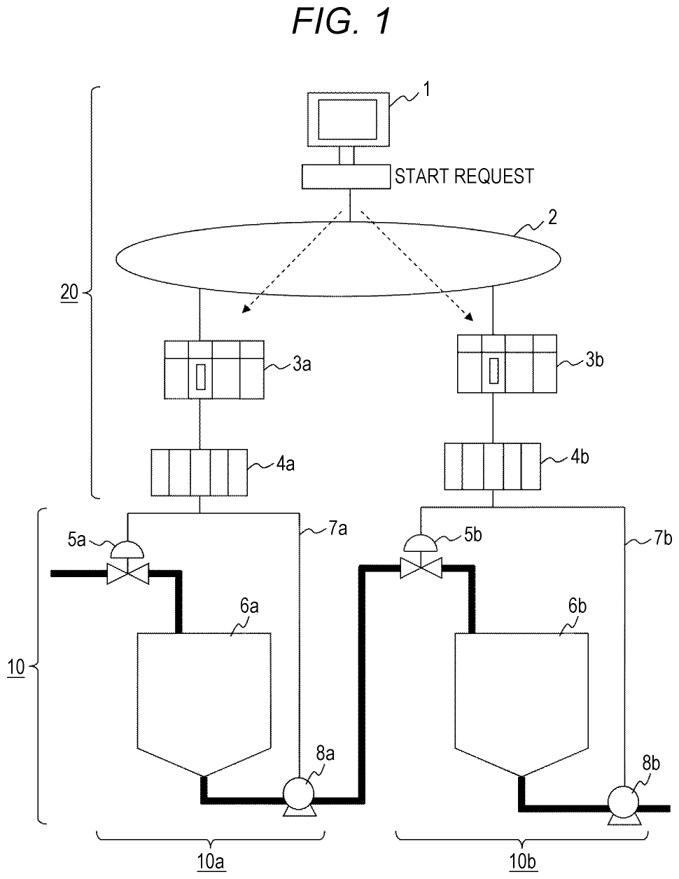

An embodiment of the invention will be described after the description of FIG. 8, but the system configuration, processing contents, and various log information as the premise will be described first with reference to FIGS. 1 to 7.

### Embodiments

FIG. 1 illustrates a configuration example of a plant monitoring and control system applied to a plant that performs a batch control. In FIG. 1, an example of a plant 10 that performs a batch control and a plant monitoring and control system 20 is illustrated.

Of these, in the plant 10 that performs a batch control, for example, two sets of batch processing units 10a and 10b are connected in series by piping, and the batch processing units 10a and 10b each are configured to include valves 5a and 5b for supplying materials, processing tanks 6a and 6b for accumulating and processing the materials, and pumps 8a and 8b for discharging the processed materials to the next batch processing unit. With this configuration, after the batch process in the batch processing unit 10a is completed, the material is transferred to the batch processing unit 10b, and a new batch process in the batch processing unit 10b is started.

In the plant monitoring and control system 20, a centralized monitoring and control device 1 and individual batch processing control devices 3a and 3b are connected to each other via a network 2. In addition, the individual batch processing control devices 3a and 3b sends a control signal to control the valves 5a and 5b and the pumps 8a and 8b, which are the operation terminals, via input/output terminals 4a and 4b and signal lines 7a and 7b. Further, the detection signal of a sensor (not illustrated) is obtained via the signal lines 7a and 7b and the input/output terminals 4a and 4b and transmitted to the centralized monitoring and control device 1.

The centralized monitoring and control device 1 is equipped with an input unit such as a keyboard and a display unit such as a monitor screen, has a Human Machine Interface (HMI) server function, monitors the plant by collecting various data of the plant, and sends a batch control command to the individual batch processing control devices 3a and 3b.

The batch control of the plant 10 is executed using the plant monitoring and control system 20 illustrated in FIG. 1. Here, the batch control is a control method using a program that operates on the individual batch processing control devices 3a and 3b defined to generate one product (or semi-finished product), in which an operation order of the facilities is controlled according to definition contents of the batch on the individual batch processing control devices 3a and 3b. When a start request is received from the centralized monitoring and control device 1, the batch control programs defined and loaded in advance in the individual batch processing control devices 3a and 3b operate. To explain a simple example, a batch process using the batch processing units 10a and 10b, which are the facilities controlled by the individual batch processing control devices 3a and 3b, operates. In the individual batch processing control device 3a, an open request is output to the valve 5a, and the product (material) is stored in the tank 6a. In the processing tank 6a, after the stored product is processed such as heating and stirring, a start request is output to the pump 8a, an open request is output from the individual batch processing control device 3b to the valve 5b, and the product is moved to the tank 6b. After the processing in the tank 6b is completed, the batch control is completed by starting the pump 8b and transporting the product to the subsequent process. In this way, the batch control is to operate a plurality of facilities according to the process order to produce a product.

The centralized monitoring and control device 1 which is a terminal for monitoring/operation by an operator displays a plant monitoring/operation screen on the centralized monitoring and control device 1 by the HMI providing function. This enables the operator to monitor and operate the plant.

In addition, the centralized monitoring and control device 1 has a user authentication function, and when the operator operates the terminal of the centralized monitoring and control device 1, the centralized monitoring and control device 1 becomes possible to operate by inputting the user ID and a password corresponding to the user ID which are assigned to the operator. Also, the login time of the operator is recorded.

While checking the plant status on the display screen of the centralized monitoring and control device 1, the operator grasps the plant status and performs screen transitions and alarm handling operations as necessary.

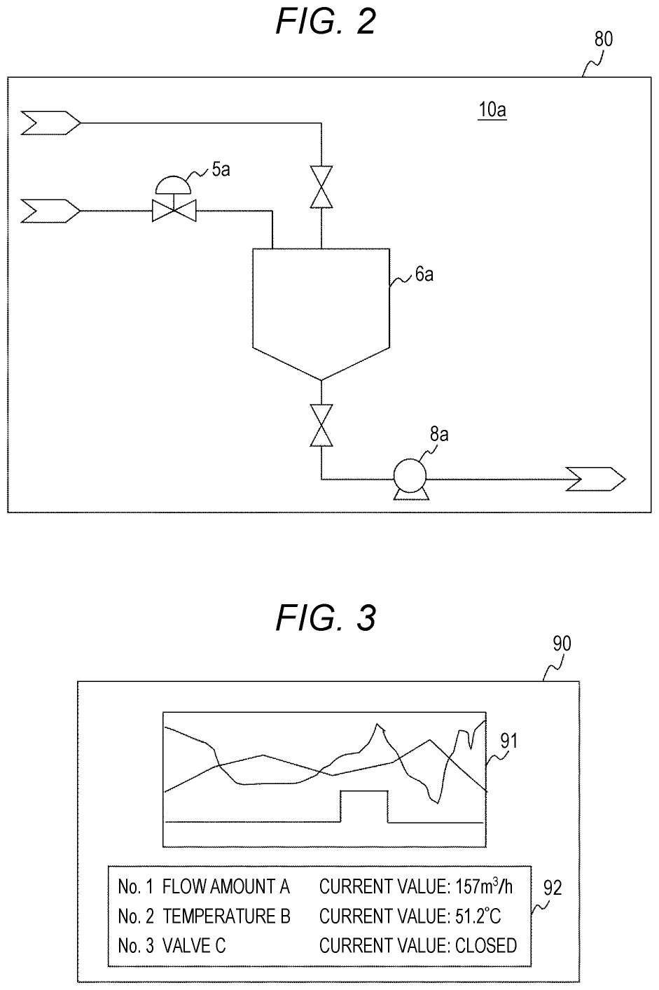

Specifically, the monitoring target or the monitoring method is changed on the screen by the screen transition. For example, as illustrated in FIG. 2 showing the plant status monitoring screen of the plant, the status of the batch processing unit 10a, which is a plant facility, is displayed in a monitor as a plant status monitoring screen 80, and the status of each facility is checked. Further, for example, as illustrated in FIG. 3 showing a trend graph screen, the status is checked by displaying a time series 91 of each facility as a trend graph screen 90 in the monitor and presenting it together with basis data 92. In this way, the screen transition operation is to check the screen transition performed in such a series of operations and the status.

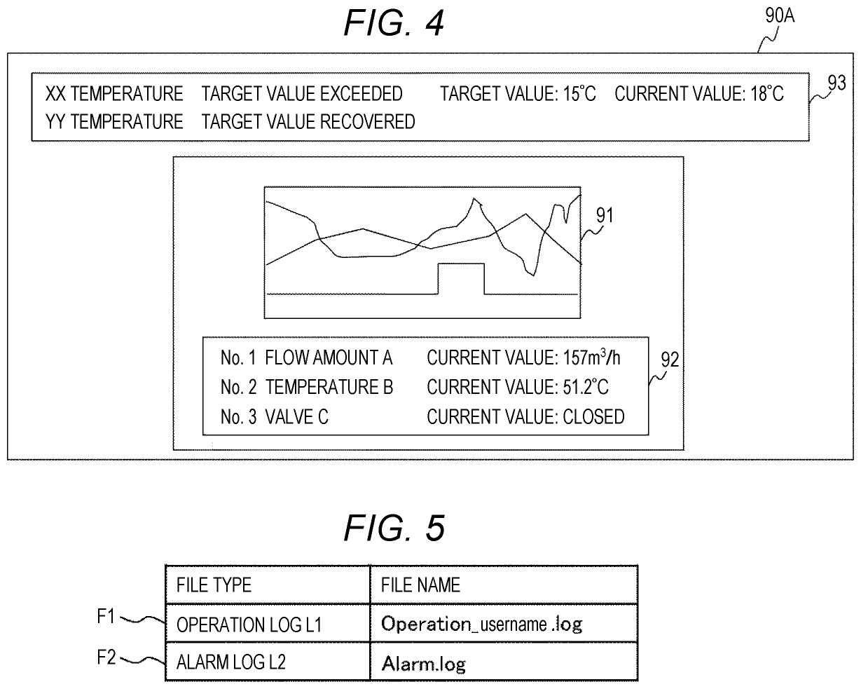

In addition, in the operation of dealing with an alarm, an operation for recovering the status is performed when an abnormality of the facility or an alarm is issued. For example, as illustrated in FIG. 4, a process value exceeds the normal range on a screen 90A when an alarm occurs on the screen 90 of FIG. 3 (in the example illustrated, the current value exceeds 18 degrees against the target temperature of 15 degrees) or falls below, a message is displayed in an alarm breaking area 93 of the monitoring screen 90A. The operator operates the facility (open/close operation, start/stop operation, adjustment of output amount and opening level) from the screen according to the output content of the message, and takes measures so that the process value is restored within the normal range. There is also an operation to prevent an alarm from occurring before the alarm occurs. For example, the valve is opened and closed to reduce the pressure before the pressure in the tank 6a reaches an alarm generation level.

In plant monitoring, the operator performs monitoring control by repeatedly performing screen transitions and alarm handling operations, and these operation details and alarm information are stored inside the computer as a log file in the form of a text file.

FIG. 5 illustrates an example of the log information held in the log file. There are two types of log files, and the user ID of the user who performed the operation is assigned to a file F1 of an operation log L1. In addition, a file F2 of an alarm log L2 stores plant alarm occurrence/recovery information regardless of the user.

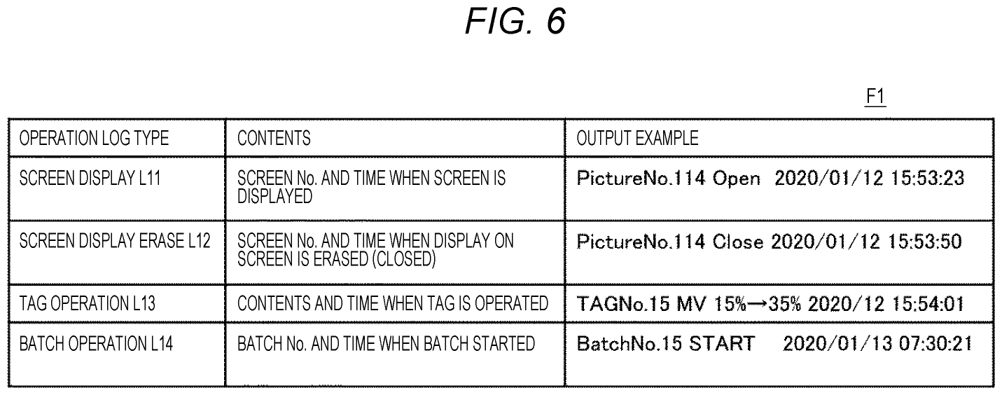

FIG. 6 illustrates the details of the operation log L1. In FIG. 6, the operation log L1 is defined by an operation log type L1a, a content L1b, and an output example L1c. There are four types of operation log L1, and a “screen display log L11” records the screen No. when the screen is displayed and the time when the operation is performed.

The screen No. is a number assigned to the monitoring screen 80 illustrated in FIG. 2 and the trend screen 90 illustrated in FIG. 3, respectively.

In a “screen display erase log L12”, the screen No. when the screen display is erased and the time when the operation is performed are recorded. In a “tag operation log L13”, the operation content and the time when the tag is operated are recorded. In the example of FIG. 6, the operation content in which the opening level of the tag No. 15 (here, the tag number assigned to a certain control valve) is changed from 15% to 35% is shown. In a “batch operation log L14”, the batch No. and the time when the batch is started are recorded.

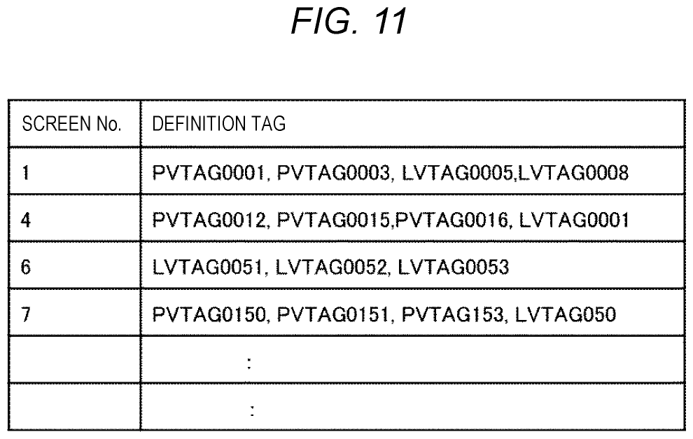

Here, the tag means a device (especially, an operating device) displayed on the screen, and the tag number is defined for each device. FIG. 11 illustrates the correspondence between the screen and the tag number (tag symbol) defined in the device displayed on the screen. For example, FIG. 11 illustrates that, when screen 1 is the status monitoring screen of the plant of FIG. 2, the tag numbers are defined and assigned such as PVTAG0001 for the valve 5A, PVTAG0003 for the tank 6a, and LVTAG0005 for the pump 8A, and are managed in the computer.

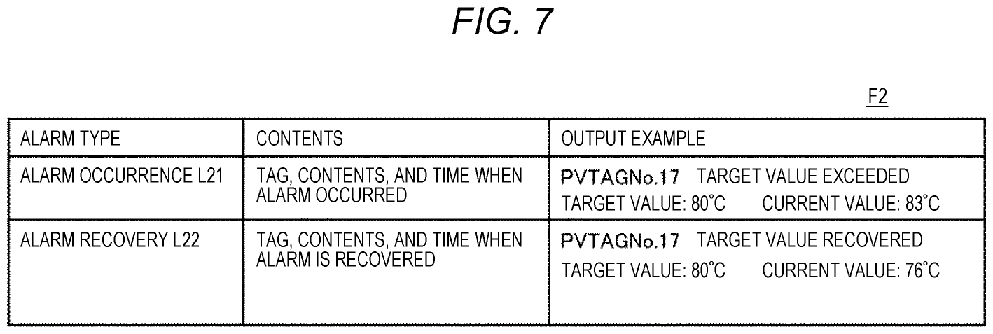

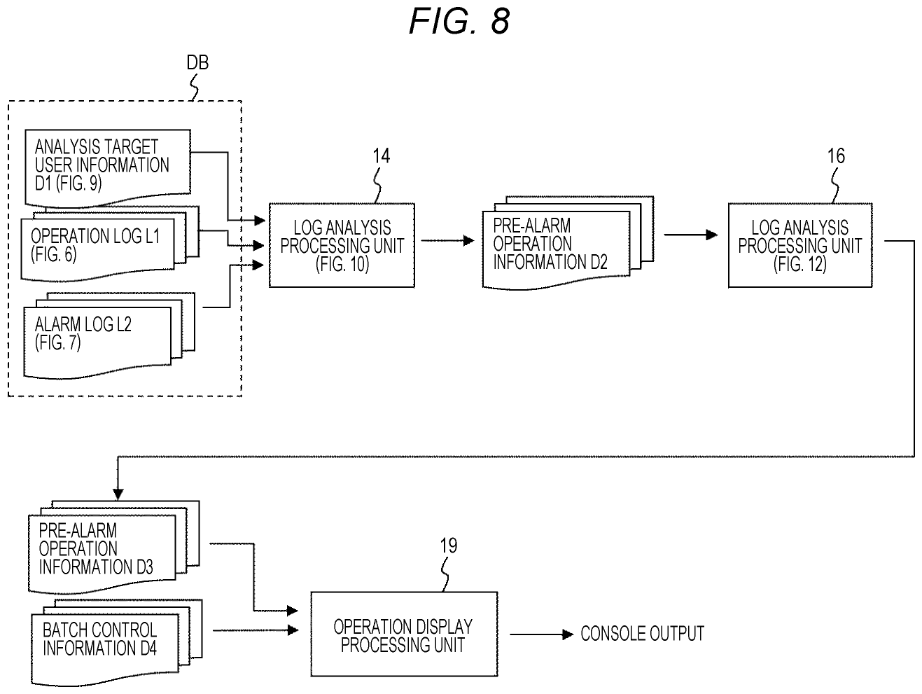

FIG. 7 illustrates the detailed information of the alarm log L2. There are two types of information in the alarm log L2. In an “alarm occurrence log L21”, the tag, the occurrence content, and the occurrence time when the alarm occurs are recorded. Further, an “alarm recovery log L22” is an alarm that occurs when the alarm is recovered under the alarm occurrence status, and the tag that the alarm has recovered, the occurrence content, and the occurrence time are recorded.

FIG. 8 illustrates the processing contents of the plant monitoring and control system according to the embodiment of the invention. This process is executed at the stage before the start of the batch process in FIG. 1, and the operation information that has been performed before the alarm occurred is created using the operation log L1 and alarm log L2 obtained at the time of the past batch process. Here, a series of processing blocks from the operation information before the alarm occurs to the confirmation instruction (console output) to the operator based on the operation information are shown.

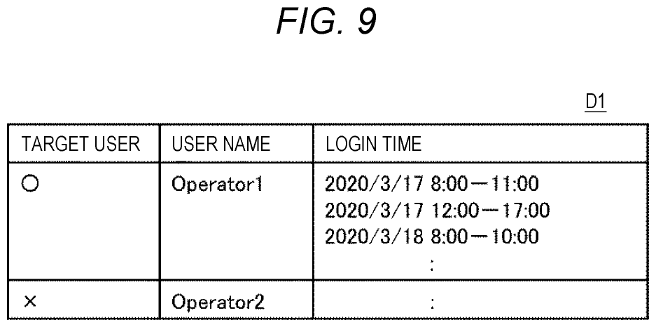

One of the information used in this process is the analysis target user information D1 illustrated in FIG. 9. The analysis target user information D1 holds information on the user name that can log in to the plant monitoring and control system and the login time. Other information used in this process is the operation log L1 illustrated in FIG. 6 and the alarm log L2 illustrated in FIG. 7. These pieces of information are appropriately stored in a database DB which receives and stores experience values in the past operation and can be referred by the user via the centralized monitoring and control device 1.

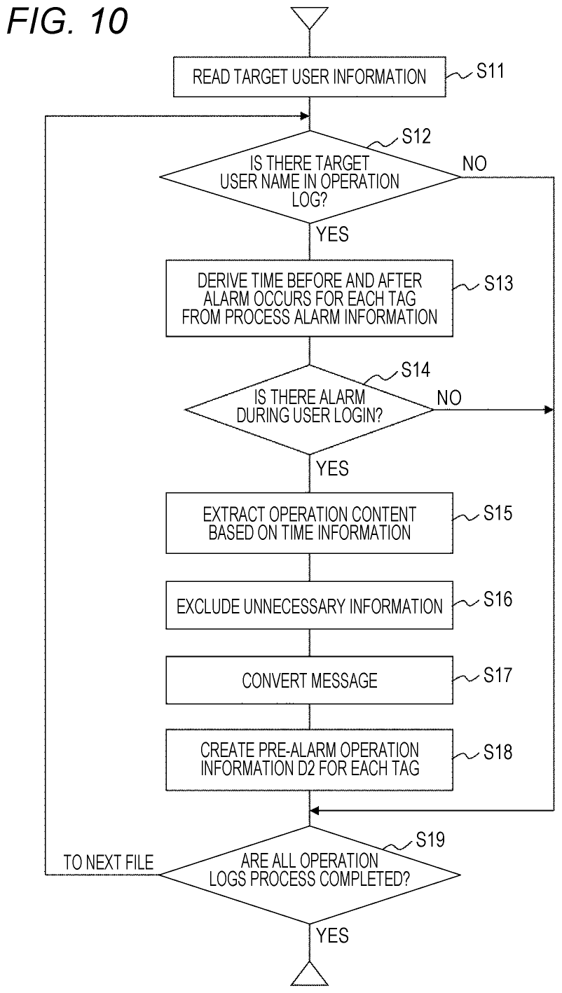

Using these operation logs L1 and alarm log L2, the log analysis processing unit 14 creates pre-alarm operation information D2. FIG. 10 illustrates a series of detailed processing flows by the log analysis processing unit 14.

In the first processing Step S11 of the processing flow of FIG. 10, the analysis target user information D1 is read and the user of the analysis target is determined. The user name determined in this case is, for example, designated by a veteran operator as an experienced operator who is preferred to be referenced for education, and thereafter, the operation log L1 and the alarm log L2 that reflect the past operation experience of the veteran operator will be referenced. As illustrated in FIG. 9 for details of the analysis target user information D1, the analysis target user information D1 has information on the user name that can log in to the system and the login time, and the user selects an operator whom the user wants as an analysis target.

In processing Step S12, according to this file, an access process is performed only for the file whose file name of the operation log L1 includes the operator name defined in the target user information, and the operation log L1 and alarm log L2 which are experienced by the selected veteran operator in the past are extracted.

Next, in the processing Step S13, the time before and after the alarm occurrence for each tag is derived from the alarm occurrence information L21 in the alarm log L2 that the selected operator has experienced in the past. In the process alarm log L2, the occurrence (L21) and the recovery (L22) are paired, and the time is derived based on the time information between the alarm recovery and the next alarm occurrence in the same tag.

Next, in the processing Step S14, it is determined whether the target operator has logged in to the system based on the above-mentioned time information, and only a case where an alarm occurs during login is passed to the next process.

Next, in the processing Step S15, the operation performed within the time is extracted from the operation log L1. Next, in the processing Step S16, among the information of the screen expansion operation (repeated operation of the screen display log L11 and the screen display erase log L12) included in the extracted operation log L1, if the screen expansion time is shorter than the threshold, the information is excluded as erroneous operation or unnecessary information. In other words, the screen with a short screen display is determined to be a screen that the veteran operator has little need to see and is not interested in, and is deleted as not worth referring to. On the contrary, the screen with a long screen display is determined to be a screen that the veteran operator has highly need to see and is interested in, and is extracted as worth referring to. However, since it can be considered that the screen that has been continuously displayed for a longer time than necessary is simply displayed, it is better to set the width of the display time appropriately.

Next, in the processing Step S17, the message conversion process is performed. The message conversion process converts the operation content including a specific numerical value into another character string. For example, if the operation message contains the message “MV 15%→30%”, it is set as “MV increase operation” (in the opposite case, decrease operation). This is because the specific numerical designation operation content differs depending on the status of the plant. In the processing Step S18, these processes are performed to create the pre-alarm operation information D2 for each tag. By this process, it is possible to extract the operation information performed before the alarm is generated for each tag and therefore for each device. The above series of processes are repeated and continuously executed until the processing of all operation logs is completed at the determination of the processing Step S19.

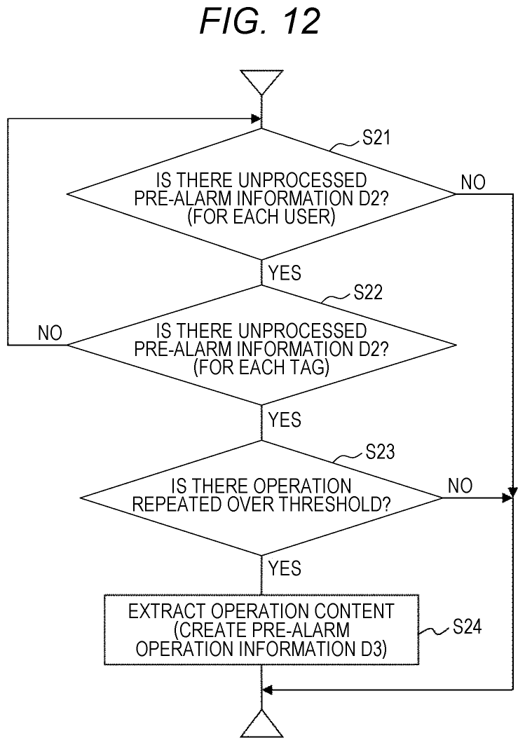

In addition, the log analysis processing unit 16 creates pre-alarm operation information D3. FIG. 12 illustrates the processing flow of the log analysis processing unit 16.

The log analysis processing unit 16 refers to all the pre-alarm operation information D2 and confirms whether there is any process that is repeatedly performed for each tag. When the repetition is performed over a certain threshold, it is regarded as a steady operation effective for tag confirmation, the corresponding operation information is extracted, and the pre-alarm operation information D3 is created.

Specifically, in the process of FIG. 12, unprocessed pre-alarm operation information D2 is extracted for each user in processing Step S21, and then unprocessed pre-alarm operation information D2 is extracted for each tag in processing Step S22. Note that all the pre-alarm operation information D2 is extracted by the repeated process here. In the processing Step S23, when the repeated operation is performed over a certain threshold, the operation is regarded as a steady operation effective for confirming the tag and extracted.

If it does not reach the threshold, it will not be used as a reference. In the processing Step S23, the extracted corresponding operation information is set as the pre-alarm operation information D3.

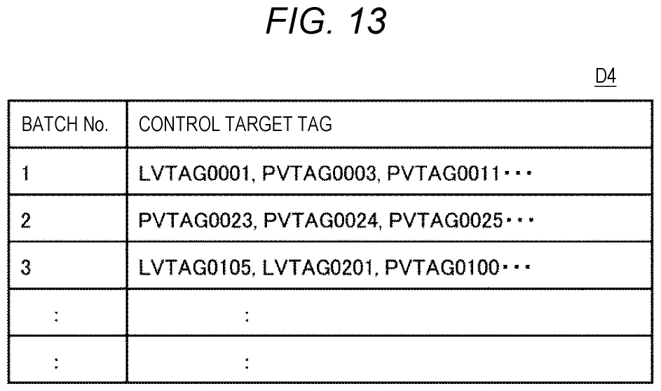

Returning to FIG. 8, the operation display processing unit 19 displays the operation contents to be confirmed during batch startup to the operator at the time of batch startup based on the pre-alarm operation information D3 and batch control information D4. The details of the batch control information D4 are illustrated in FIG. 13. The batch control information D4 has information on which tag (operating device) the operation instruction is given to in the batch for each batch No.

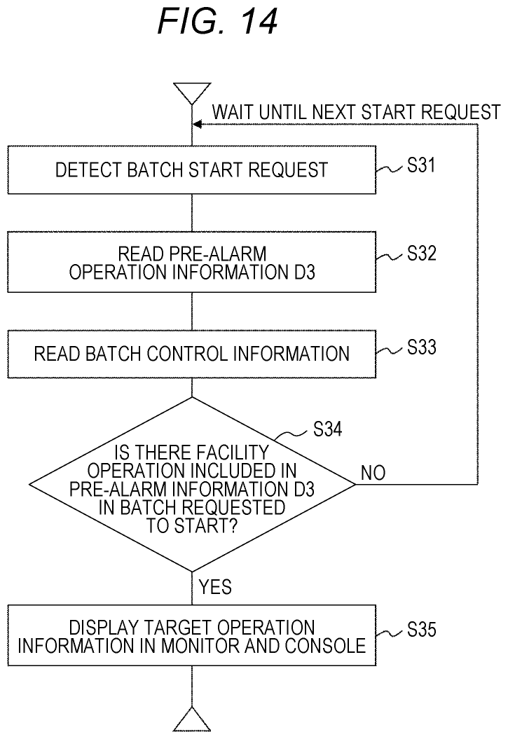

FIG. 14 is a flowchart illustrating the processing contents of the operation display processing unit 19. According to this flow, the batch start request is received in the processing Step S31, and the pre-alarm operation information D3 and the batch control information D4 are taken in the processing Steps S32 and S33 on this condition. In processing Step S34, it is confirmed that the batch process for which there is a start request includes the device operation included in the pre-alarm operation information D3. When there is a device operation, the target operation information is displayed on the monitor and console in the processing Step S35.

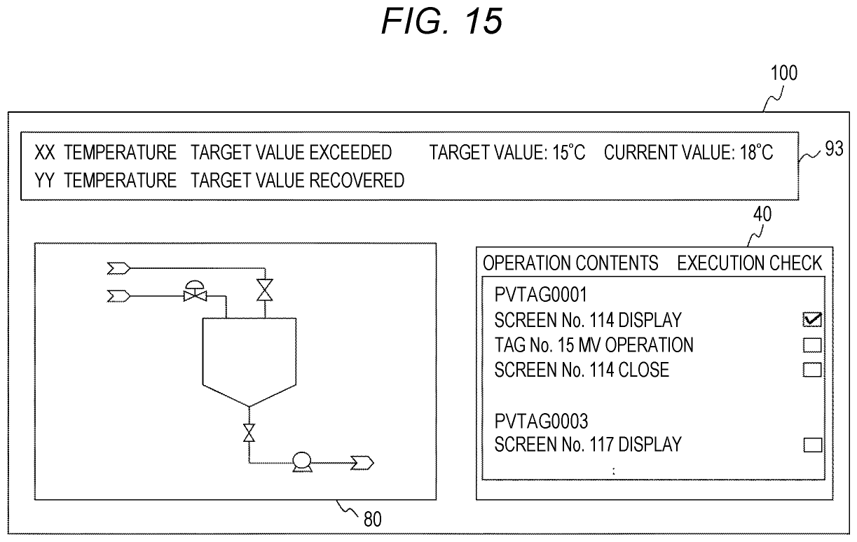

Further, the operation display processing unit 19 searches which tag is the control target based on the information of the batch No. instructed to start when the batch start operation instruction is given. If the started batch No. contains the same tag as the tag included in the pre-alarm operation information D3, the operation content is displayed in an operation content display area 40 on the operation screen 100 illustrated in FIG. 15.

FIG. 15 illustrates a configuration example of the operation screen 100. Here, an example in which the operation content display area 40 is displayed together with the plant configuration screen 80 and the alarm breaking area 93 is shown, and the screen is configured so that these can be referred to in a list. In this example, the operation content display area 40 is displayed on the right side of the monitoring screen 100. The operation information included in the pre-alarm operation information D3 is displayed in the screen operation content display area 40. In addition, when the operator performs the same operation as the displayed operation, there is a check box to be checked. As a result, the operator can be prompted to perform the same operation. If there is operation information for multiple tags among the tags operated in the batch, the tags are displayed in the order of operation of the tags in the batch. As described above, the monitor screen of FIG. 15 is provided with a check box as an input means for displaying the operation information included in the pre-alarm operation information D3 and performing the verification (check).

The invention can also be grasped as a program invention. This can be realized as a plant monitoring and control program for referring to a database DB that stores a status of past batch control execution for a plant as an operation log regarding an operating device and an alarm log when an alarm occurs, and for a batch control of the plant, which includes a first log analysis processing program (log analysis processing unit 14) that extracts first information regarding a pre-alarm device operation occurs from the database DB, a second log analysis processing program (log analysis processing unit 16) that extracts a fact that the pre-alarm device operation is executed for one device multiple times as second information regarding the pre-alarm device operation, and a displaying program (operation display processing unit 19) that prompts verification of the second information.

The plant monitoring and control program is stored in a memory such as in the centralized monitoring and control device 1.

What is claimed is:

1. A plant monitoring and control system for a batch control of a plant, comprising:
a database that stores a status at a time of executing a past batch control for the plant as an operation log regarding an operating device and as an alarm log at a time of alarm occurrence;
a first log analysis processing unit that extracts first information regarding a pre-alarm device operation occurs from the database; and
a second log analysis processing unit that extracts a fact that the pre-alarm device operation is executed for one device multiple times as second information regarding the pre-alarm device operation,
wherein the second information is prompted to be verified.

2. The plant monitoring and control system according to claim 1,
wherein the database includes user information at a time of performing a past batch control, and the first information regarding the pre-alarm device operation operated by a designated user is extracted.

3. The plant monitoring and control system according to claim 1,
wherein the plant monitoring and control system performs a plurality of batch controls for a plurality of processes constituting a plant, and extracts past information of a process for which a batch process is requested, with reference to the database.

4. The plant monitoring and control system according to claim 1, comprising:
a monitor for displaying the second information; and
an input unit for performing verification.

5. A plant monitoring control method for performing a batch control for a plant, comprising:
storing a status at a time of executing a past batch control for the plant as an operation log regarding an operating device and as an alarm log at a time of alarm occurrence;
extracting first information regarding a pre-alarm device operation from the stored information;
extracting a fact that the pre-alarm device operation is executed for one device multiple times as second information regarding the pre-alarm device operation; and
prompting the second information to be verified.

6. A non-transitory computer-readable storage medium storing a plant monitoring and control program for referring to a database that stores a status at a time of executing a past batch control for a plant as an operation log regarding an operating device and as an alarm log at a time of alarm occurrence, and for a batch control of the plant, comprising:
a first log analysis processing program that extracts first information regarding a pre-alarm device operation from the database;
a second log analysis processing program that extracts a fact that the pre-alarm device operation is executed for one device multiple times as second information regarding the pre-alarm device operation; and
a displaying program that prompts verification of the second information.
